(19) United States
(12) Patent Application Publication
(10) Pub. No.: US 2021/0214984 A1
(43) Pub. Date: Jul. 15, 2021

(54) DOUBLE-ACTING DOOR

(71) Applicant: HUFCOR, Inc., Janesville, WI (US)

(72) Inventors: Arthur A. McNutt, Milton, WI (US); Kurt E. Rebarchek, Janesville, WI (US); Gary R. Southern, McFarland, WI (US); Andrew T. Williams, Edgerton, WI (US)

(21) Appl. No.: 16/855,308

(22) Filed: Apr. 22, 2020

Related U.S. Application Data
(60) Provisional application No. 62/961,364, filed on Jan. 15, 2020.

(51) Int. Cl. E05F 7/02; E06B 1/52

(52) U.S. Cl. CPC E05F 7/02; E06B 7/16; E05Y 2900/132; E06B 1/52

(57) ABSTRACT

A moveable wall includes a panel and a door that pivots with respect to the panel. A moveable bottom panel portion is connected to and can move with respect to a bottom edge of the panel. A panel height adjustment assembly can move the moveable bottom panel portion with respect to the bottom edge of the panel into and out of engagement with a floor surface. The panel height adjustment assembly is activated by a user without the use of tools. A moveable bottom door portion is connected to and can move with respect to a bottom edge of the door. A door height adjustment assembly can move the moveable bottom door portion with respect to the bottom edge of the door so that the moveable bottom door portion is adjacent the floor surface. The door height adjustment assembly is activated by a user without the use of tools.

### CROSS REFERENCE TO RELATED APPLICATION

This application claims priority to U.S. Provisional Application No. 62/961,364, filed Jan. 15, 2020, the entire contents of which are herein incorporated by reference.

### BACKGROUND

The present invention relates to double-acting doors, specifically double-acting doors in a moveable wall.

### SUMMARY

In one embodiment, the invention provides a moveable wall for use in a building that has a fixed wall, a floor surface and a ceiling. The moveable wall includes a panel having a door frame that includes a side jam and a head jam. The panel also includes a top edge positioned adjacent to the ceiling, a bottom edge positioned near the floor surface, a first side edge that extends from the bottom edge to the top edge, and a second side edge that extends from the head jam to the top edge. The bottom edge extends between the first side edge and the side jam. A door includes a hinge edge that is mounted on a hinge axis to pivot about the side jam and a strike edge that is opposite the hinge edge. When the door is in a closed position, the door is parallel to the panel. The door can pivot to a first open position when the door is pivoted about the hinge axis from the closed position in a first pivoting direction, and to a second open position when the door is pivoted about the hinge axis from the closed position in a second pivoting direction opposite the first pivoting direction. A moveable bottom panel portion is connected to and moves with respect to the bottom edge of the panel. A height adjustment assembly moves the moveable bottom panel portion with respect to the bottom edge of the panel into and out of engagement with the floor surface. The height adjustment assembly is activated by a user without the use of tools.

In some embodiments, a moveable wall for use in a building that has a fixed wall, a floor surface and a ceiling. The moveable wall includes a panel having a door frame that includes a side jam and a head jam. The panel also includes a top edge positioned adjacent to the ceiling, a bottom edge positioned near the floor surface, a first side edge that extends from the bottom edge to the top edge, and second side edge that extends from the head jam to the top edge. The bottom edge extends between the first side edge and the side jam. A door includes a hinge edge that is mounted on a hinge axis to pivot about the side jam and a strike edge that is opposite the hinge edge. The door also includes a top edge positioned adjacent the head jamb, and a bottom edge positioned near the floor surface. When the door is in a closed position, the door is parallel to the panel. The door can pivot to a first open position when the door is pivoted about the hinge axis from the closed position in a first pivoting direction, and a second open position when the door is pivoted about the hinge axis from the closed position in a second pivoting direction opposite the first pivoting direction. A moveable bottom door portion is connected to and moves with respect to the bottom edge of the door. A height adjustment assembly can move the moveable bottom door portion with respect to the bottom edge of the door such that the moveable bottom door portion is adjacent the floor surface. The height adjustment assembly is activated by a user without the use of tools.

In some embodiments, a moveable wall for use in a building that has a fixed wall, a floor surface and a ceiling. The moveable wall includes a panel that has a door frame including a side jam and a head jam. The panel also includes a top edge positioned adjacent to the ceiling, a bottom edge positioned near the floor surface, a first side edge that extends from the bottom edge to the top edge, and a second side edge that extends from the head jam to the top edge. The bottom edge extends between the first side edge and the side jam. A moveable bottom panel portion is connected to and can move with respect to the bottom edge of the panel. A panel height adjustment assembly can move the moveable bottom panel portion with respect to the bottom edge of the panel into and out of engagement with the floor surface. The panel height adjustment assembly is activated by a user without the use of tools. A door includes a hinge edge that is mounted on a hinge axis to pivot about the side jam and a strike edge that is opposite the hinge edge. The door also includes a top edge positioned near the head jamb, a bottom edge positioned near the floor surface. When the door is in a closed position, the door is parallel to the panel. The door can pivot to a first open position when the door is pivoted about the hinge axis from the closed position in a first pivoting direction, and a second open position when the door is pivoted about the hinge axis from the closed position in a second pivoting direction opposite the first pivoting direction. A moveable bottom door portion is connected to and can move with respect to the bottom edge of the door. A door height adjustment assembly can move the moveable bottom door portion with respect to the bottom edge of the door such that the moveable bottom door portion is adjacent the floor surface. The door height adjustment assembly is activated by a user without the use of tools.

In some embodiments, the moveable wall further includes a second panel having a top edge positioned adjacent to the ceiling, a bottom edge positioned near the floor surface, a first side edge that extends from the bottom edge to the top edge, and second side edge that extends from the bottom edge to the top edge. The first side edge is positioned adjacent to the fixed wall and the second side edge is positioned adjacent to the first side of the first panel while the first and second panels are deployed. A third panel includes a top edge positioned adjacent to the ceiling, a bottom edge positioned near the floor surface, a first side edge that extends from the bottom edge to the top edge, and second side edge that extends from the bottom edge to the top edge. The first side edge is positioned adjacent to the second side of the first panel while deployed. An edge of the door is positioned near to the first side of the third panel when the door is in the closed position and the first and third panels are deployed. Gaskets are positioned on the strike edge of the door, on the hinge edge of the door, on side jam of the door frame, and on the first edge of the third panel. The gaskets close a first gap between the hinge edge of the door and the side jam and close a second gap between the strike edge of the door and the first edge of the third panel.

In some embodiments, a door closure has a first portion connected to the top edge of the door, a second portion connected to the head jam, and a third portion connected to the first portion and the second portion. The door closure prevents rotation of the door from the closed position more than 90 degrees in either of the first and second pivoting directions. At least one sweep is mounted to at least one of the top edge of the door and the head jam to close a gap between the top edge of the door and the head jam.

In some embodiments, support rails extend horizontally between the strike side and the hinge side of the door. The support rails spaced vertically apart between a top of the door and a bottom of the door. Brackets extend between the corners at which the hinge side, the strike side, the top of the door and the bottom of the door intersect. The support rails and the brackets resist deflection of the door during operation.

Other aspects of the invention will become apparent by consideration of the detailed description and accompanying drawings.

### BRIEF DESCRIPTION OF THE DRAWINGS

FIG. 1 is a perspective view of an operable wall having multiple panels.

FIG. 2 is a perspective view of a double acting door panel with a door in a closed position.

FIG. 3 is a perspective view of the double acting door panel with the door in an open position.

FIG. 4 is a close up view of a portion of the double acting door panel with the door in the closed position.

FIG. 5 is a close up view of the portion of the double acting door panel with the door in the open position.

FIG. 6 is an exploded perspective view of a door frame and the door of the double acting door panel.

FIG. 7 is a bottom perspective view of a connection between the door frame and the double acting door panel.

FIG. 8 is a front exploded view the door and a closure mechanism.

FIG. 9 is a close up view of a frame height adjustment assembly of FIG. 6.

FIG. 10 is an exploded view of a door height adjustment assembly.

FIG. 11 is a perspective view of the door height adjustment assembly.

FIG. 12 is a front view of a support system of the door.

FIG. 13 is a perspective view of the panel showing gaskets with the door in the closed position.

FIG. 14 is a perspective view of the panel showing the gaskets with the door in the open position.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

As used herein “proximate” means near, but not necessarily in contact with. The term “proximate” means that a small gap exists between the elements that is greater than a nominal crack size. As used herein “adjacent” means “having or sharing a common boundary or in contact with.” The term “adjacent” includes a small crack or gap between elements. The term adjacent means that the elements are closer than the term proximate as used herein. The term “in engagement with” means that the elements are in direct contact with one another with no space between the elements.

Embodiments of the invention are described below with respect to an operable wall having panels. The term “surface” is used for the wide surfaces of the panels, and a door in one of the panels, that face into rooms or spaces on opposite sides of the deployed wall. The term “edge” is used for the perimeters of the surfaces and any space between the perimeters, generally extending along the top, bottom, and vertical ends of the panels and door. The “edges” generally have a very small surface area compared to the “surfaces.” In a deployed condition, the edges of panels face the ceiling, floor, adjacent panels, and fixed walls of the building in which the operable wall is installed. The door edges face the floor, door frame and a portion of the edge of an adjacent panel, as will be discussed more fully below.

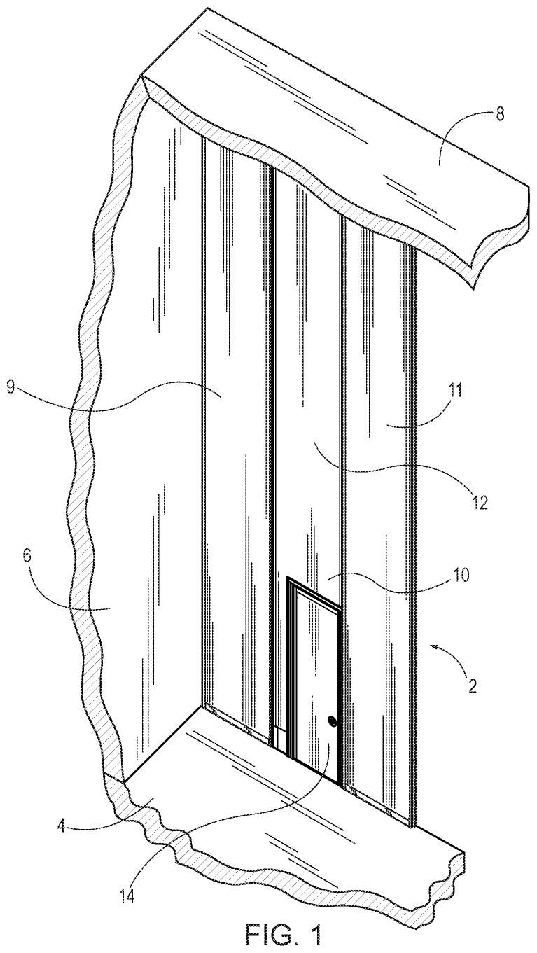

FIG. 1 illustrates an operable wall 2 for use in a building having a floor surface 4, a fixed wall 6 and a ceiling 8. Such operable walls can be used to partition large spaces such as conference halls, gymnasiums, and the like. The illustrated operable wall 2 includes a first panel 9, a second panel 10 and a third panel 11. The first panel 9 includes a top edge, a bottom edge, a first side edge, a second side edge, a first surface and a second surface. The top edge is positioned adjacent to the ceiling 8 and the bottom edge is positioned proximate the floor surface 4. The first and second side edges both extend from the bottom edge to the top edge. The first side edge is positioned adjacent to the fixed wall 6.

The second panel 10 includes a top edge, a bottom edge, a first side edge, a second side edge, a first surface and a second surface. The top edge is positioned adjacent to the ceiling 8 and the bottom edge is positioned proximate the floor surface 4. The first side edge extends from the bottom edge to the top edge. The second side edge extends from a location between the bottom edge and the top edge to the top edge. The first side edge is positioned adjacent to the second side edge of the first panel 9 while the first and second panels 9, 10 are deployed. As described in more detail below, the second panel 10 includes a frame 12 and a door 14.

The third panel 11 includes a top edge, a bottom edge, a first side edge, a second side edge, a first surface and a second surface. The top edge is positioned adjacent to the ceiling 8 and the bottom edge is positioned proximate the floor surface 4. The first and second side edges extend from the bottom edge to the top edge. The first side edge is positioned adjacent to the second side of the second panel 10 while deployed, such that an edge of the door 14 is positioned proximate the first side of the third panel 11 when the door 14 is in the closed position. When deployed, the first surfaces of the first, second and third panels 9, 10, 11 form a first plane and the second surfaces of the first, second and third panels 9, 10, 11 form a second plane. While the door 14 is closed, a first surface of the door 14 is substantially aligned with the first plane and a second surface of the door 14 is substantially aligned with the second plane.

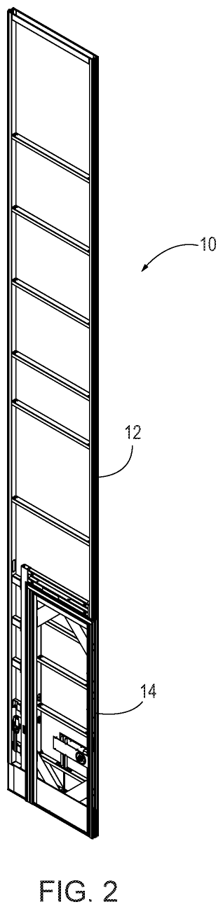

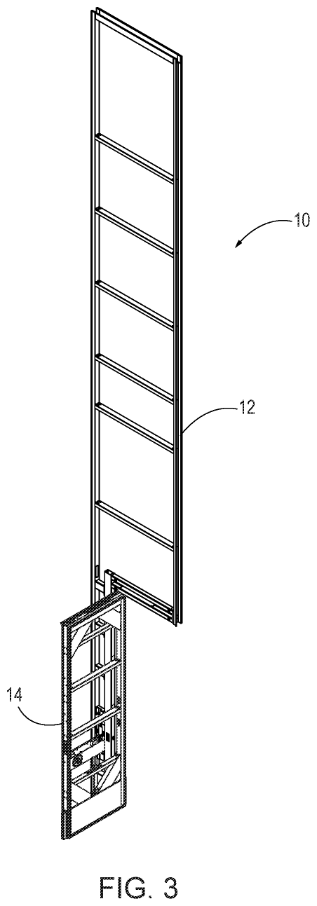

FIGS. 2 and 3 illustrate the second panel 10 in greater detail. The moveable wall panel 10 is a double acting door panel including the frame 12 and the door 14. As used herein, the term “double acting” when describing the movable wall panel 10 means a door that swings open in both directions. The frame 12 defines an opening configured to receive the door 14. The door 14 is pivotable with respect to the frame 12 between a closed position shown in FIG. 2, in which the door 14 closes or blocks the opening, and a first open position shown in FIG. 3, in which the door 14 permits access to and through the opening.

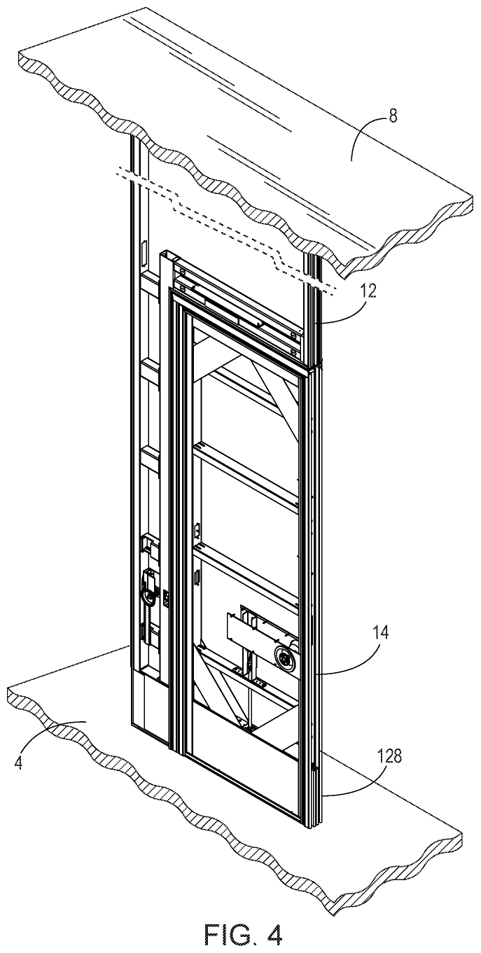

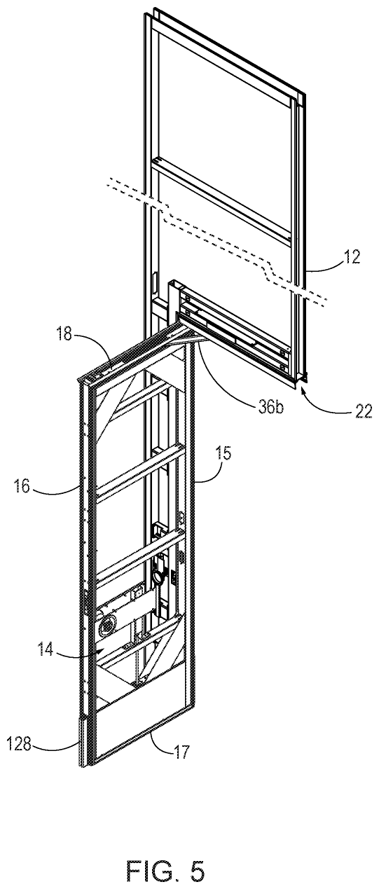

FIGS. 4 and 5 illustrate a lower portion of the wall panel 10 (in which the opening is formed) in greater detail. As seen in FIG. 5, the frame 12 defines a top edge adjacent the ceiling 8, a bottom edge adjacent the floor surface 4, and an opening having a side jam and a head jamb 22. The other side of the opening is provided by an adjacent panel 9, 11 or a wall 6 of the building in which the operable wall is installed. The frame 12 defines a first side edge extending from the bottom edge to the ceiling and a second side edge extending from the ceiling 8 to the head jamb 22. The bottom of the opening is bounded by the floor surface 4 of the building in which the operable wall is installed. The opening is sized to receive the door 14.

The door 14 has a hinged side edge 15 adjacent to and hingedly mounted on a hinge axis to the side jamb 20, a strike edge 16 opposite and parallel to the hinged side edge 15, a bottom edge 17 proximate the floor surface 4, and a top edge 18 proximate the head jamb 22 of the frame 12 that bounds the top of the opening. The door 14 is parallel to the panel 10 when the door is closed. The door 14 can be pivoted about the hinge axis in a first pivoting direction to a first open position (shown in FIG. 5), and pivoted in a second pivoting direction to a second open position (extending approximately 180 degrees from the position shown in FIG. 5). The second pivoting direction is opposite the first pivoting direction.

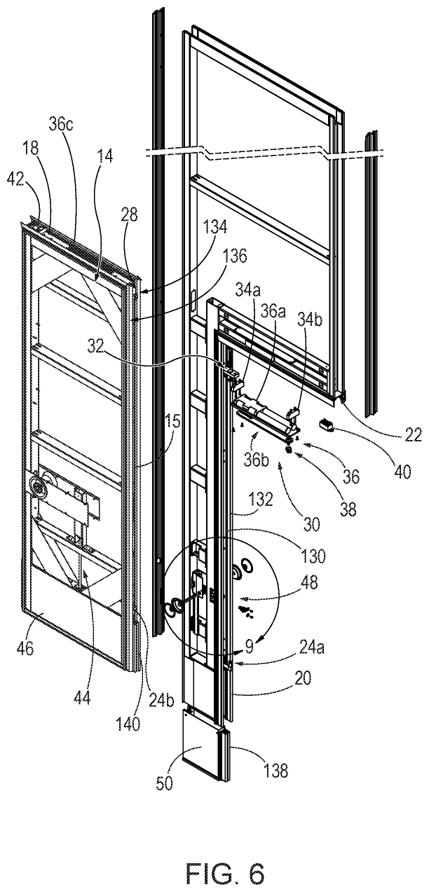

FIG. 6 illustrates a lower portion of the wall panel 10 with the door 14 exploded from the frame 12 for clarity. The frame opening includes the side jamb 20, the head jamb 22 and a frame bottom hinge 24a. The frame bottom hinge 24a protrudes from the side jamb 20 of the frame 12 and is configured to engage the hinged side edge 15 of the door 14. The door 14 further includes a door bottom hinge 24b and a door top hinge 28. The door bottom hinge 24b is connected to the hinged side edge 15 and is sized to connect to the frame bottom hinge 24a to permit the door 14 to pivot with respect to the frame 12. The door top hinge 28 is connected to the hinged side edge 15 and is configured to engage the frame 12.

FIG. 6 also illustrates a closure mechanism 30 that connects the door 14 to the frame 12 and urges the door 14 to the closed position. The top edge 18 of the door 14 is spaced apart from the head jamb 22 somewhat to accommodate the closure mechanism 30 between the top edge 18 of the door 14 and the head jamb 22. The illustrated closure mechanism 30 engages the door top hinge 28 and permits the door 14 to pivot approximately 180 degrees between the first open position and a second open position in which the door 14 is pivoted through the opening to the opposite side of the wall panel 10. The closure mechanism 30 includes a carrier plate 32, first and second spacer blocks 34a, 34b, a door closure 36, a hold-open roller 38, a first latch 40, and a second latch 42 (on the top edge 18 of the door 14). The carrier plate 32 is connected to the frame 12 and the door top hinge 28. The door 14 is pivotably connected to the frame 12 by the frame bottom hinge 24a, the door bottom hinge 24b, the door top hinge 28 and the carrier plate 32.

The first spacer block 34a connects to a bottom surface of the carrier plate 32 and to a top surface of the door closure 36. The second spacer block 34b connects to the head jamb 22 of the frame opening and to the top surface of the door closure 36. The first and second spacer blocks 34a, 34b position the door closure 36 at a desired distance from the head jamb 22 of the door frame 12.

The door closure 36 includes an upper portion 36a, a middle portion 36b and a lower portion 36c (on the top edge 18 of the door 14). The upper portion 36a is connected to the spacer blocks 34a, 34b and is inhibited from rotating with respect to the frame 12. The middle portion 36b is connected to the door 14 and is permitted to rotate with respect to the upper portion 36a and the frame 12. The middle portion 36b includes an aperture sized to receive the hold-open roller 38. The lower portion 36c is connected to a top edge 18 of the door 14 and is configured to receive the hold-open roller 38. The illustrated lower portion 36c is a track sized to permit the hold-open roller 38 to slide along the track in response to the door 14 opening and closing.

The first latch 40 is connected to the frame head jamb 22 and the second latch 42 is connected to the door top edge 18. The first latch 40 and the second latch 42 cooperate to retain the door 14 in the closed position. The first latch 40 has a downwardly extending protrusion, and the second latch 42 has an upper surface defining two ramps and a detent between the ramps. The detent is configured to receive the downwardly extending protrusion of the first latch 40 to thereby retain the door 14 in the closed position.

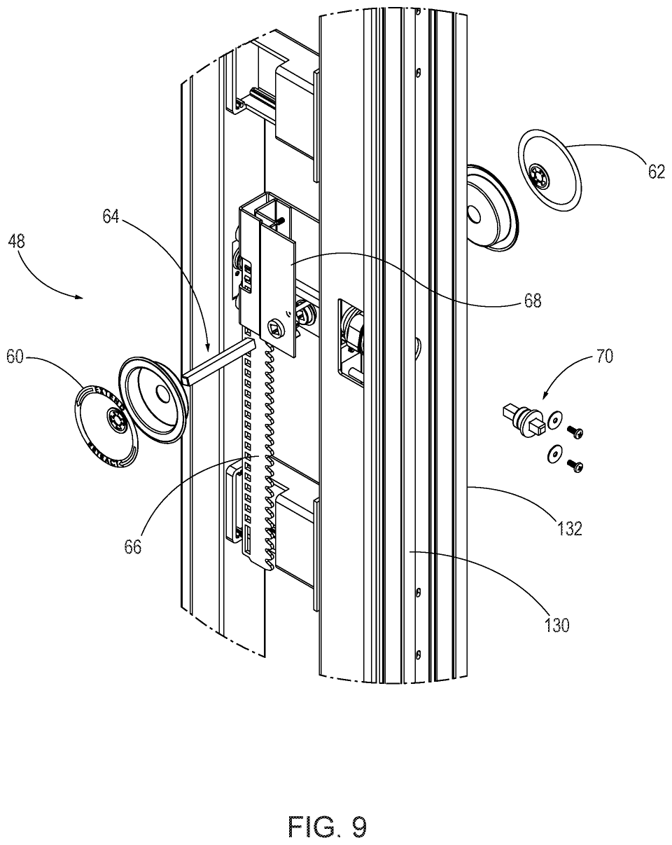

FIG. 6 further illustrates a door height adjustment assembly 44, a moveable bottom door portion 46, a frame height adjustment assembly 48, and a moveable bottom frame portion 50. The door height adjustment assembly 44 is configured to move the bottom door portion 46 with respect to the bottom edge 17 of the door 14 to narrow a gap between the bottom edge 17 of the door 14 and the floor surface 4 such that the bottom of the bottom door portion 46 is adjacent the floor surface 4. The frame height adjustment assembly 48 is configured to move the moveable bottom frame portion 50 with respect to the bottom edge of the panel 10 into and out of engagement with the floor surface 4. The door height adjustment assembly 44 and the frame height adjustment assembly 48 are shown in greater detail in FIGS. 9-11 and will be discussed in more detail below.

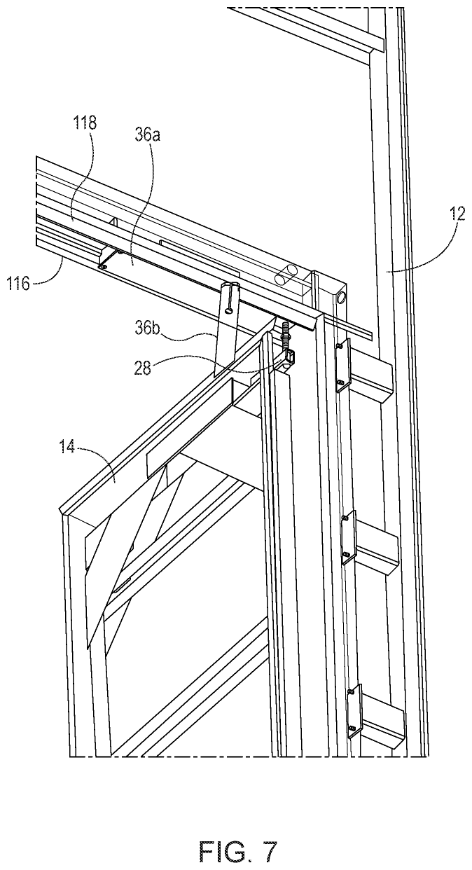

FIG. 7 illustrates the connection between the upper portion 36a and the middle portion 36b when the door 14 is in an open position. The upper portion 36a remains fixed to the frame 12. The middle portion 36b has one end that is pivotally connected to the upper portion 36a and a second end that is connected to the lower portion 36c. The middle portion 36b pivots with respect to the frame 12 and slides along the top edge 18 of the door 14 when the door pivots open or closed.

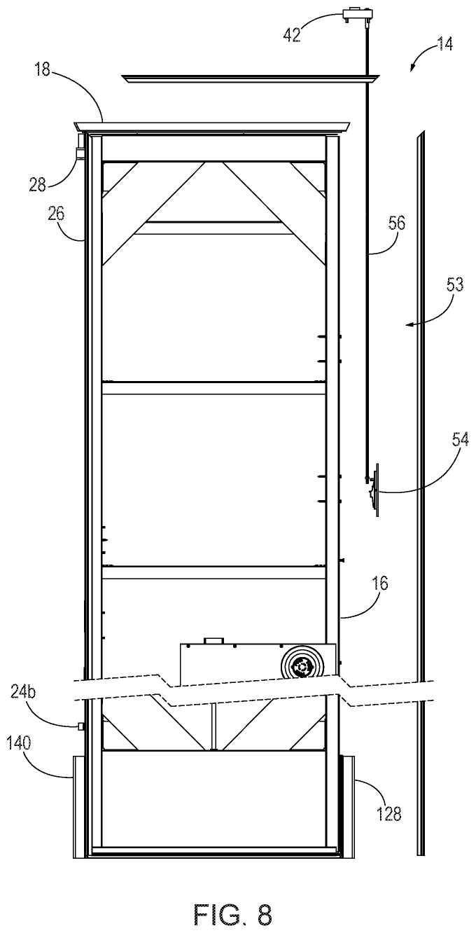

FIG. 8 illustrates a locking mechanism 53 configured to retain the door 14 in the closed position. The locking mechanism 53 is connected to the strike edge 16 of the door 14. The locking mechanism 53 includes a user-engageable component 54 and an elongate component 56. The user moves the user-engageable component 54 upward to raise the elongate component 56 and downward to lower the elongate component 56. When the elongate component 56 is raised, it extends into an aperture in the second latch 42 to fix the door 14 to the frame 12 and thereby retain the door 14 in the closed position. When the elongate component 56 is lowered, it is spaced from the first latch 40 to thereby permit the door 14 to pivot with respect to the frame 12. When the panel 10 is being moved or stored, the locking mechanism is utilized to retain the door 14 in the closed position. When the panel 10 is in use, the locking mechanism is typically unlocked.

FIG. 9 illustrates a close up view of the frame height adjustment assembly 48 taken from the circle in FIG. 6. The frame height adjustment assembly 48 includes a first cup face 60, a second cup face 62, a square drive 64, a vertical rack 66, a carriage 68, and an internal leg shaft 70. The first cup face 60 and the second cup face 62 are each configured to support a handle engageable by a user without the use of tools. The square drive 64 is rotated in response to rotation of either handle connected to the first cup face 60 or the second cup face 62. The vertical rack 66 is connected to a main portion of the frame 12.

The carriage 68 is connected to the bottom frame portion 50 (shown in FIG. 6) by the internal leg shaft 70. Rotation of the square drive 64 causes the carriage 68 to travel along the vertical rack 66, which thereby raises and lowers the bottom frame portion 50. When the panel 10 is in the desired location, a user rotates one of handles connected to the first cup face 60 or the second cup face 62 to lower the bottom frame portion 50 against the floor surface 4. The force retains the frame 12 in position against the floor surface 4 while the door 14 is permitted to rotate open and closed. In some embodiments, the bottom frame portion 50 is retained against the floor surface 4 with at least fifty pounds of force. In some embodiments, the bottom frame portion 50 is retained against the floor surface 4 with at least seventy five pounds of force. In some embodiments, the bottom frame portion 50 is retained against the floor surface 4 with at least one hundred pounds of force.

The vertical rack 66 permits the bottom frame portion 50 to adjust an overall height of the frame 12. In some embodiments, the height adjustment permitted by the vertical rack 66 can compensate for deflection of a ceiling adjacent the frame 12. In some embodiments, the vertical rack 66 permits the bottom frame portion 50 to move about five inches between a raised and a lowered position. In some embodiments, the vertical rack 66 permits the bottom frame portion 50 to move about eight inches between a raised and a lowered position. In some embodiments, the vertical rack 66 permits the bottom frame portion 50 to move about ten inches between a raised and a lowered position. In the illustrated embodiment the bottom edge of the panel 10 is “proximate” the floor surface 4 and the bottom of the bottom frame portion 50 is “in engagement with” the floor surface 4 because the panel 10 may be near but is not necessarily in contact with the floor surface 4, but the bottom frame portion 50 contacts the floor surface 4 with a sufficient force to resist movement with respect to the floor surface 4 upon opening and closing of the door 14.

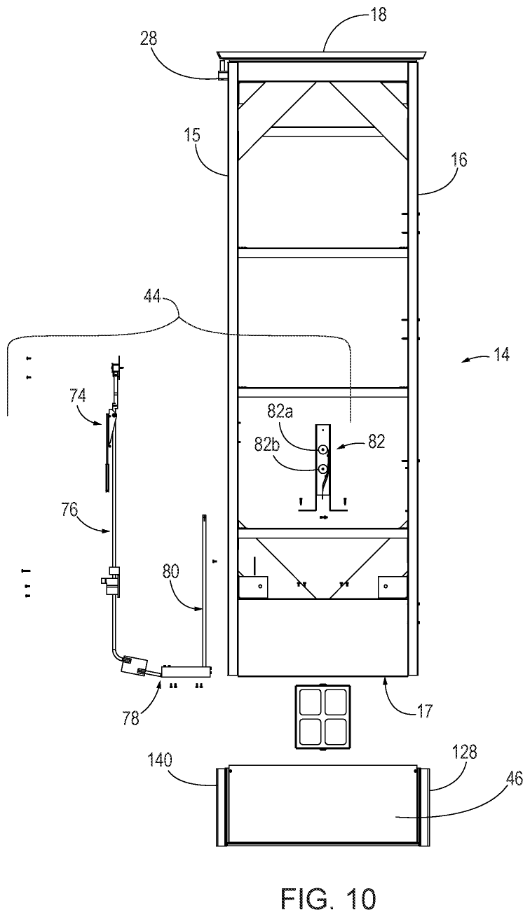

FIG. 10 shows the door height adjustment assembly 44 and the bottom door portion 46 in greater detail. The door height adjustment assembly 44 includes a handle 74, a rod 76, a bottom block 78, a plunger 80, and a seal lift assist assembly 82. The handle 74 is positioned on the hinged side edge 15 of the door 14 and is pivotable with respect to the door 14 while the door 14 is open. The rod 76 extends along the hinged side edge 15 of the door 14 and is vertically moveable with respect to the door 14. The handle 74 pivots between a locked position (shown in FIG. 10) in which the handle 74 retains the rod 76 in position and an unlocked position (rotated outward from the hinged side edge 15) in which the rod 76 is permitted to move vertically with respect to the handle 74. In some embodiments, the handle 74 includes one or more cam surfaces that press against the rod 76 while the handle 74 is in the locked position. The bottom block 78 is connected to the rod 76 and is connected to the bottom door portion 46. The bottom block 78 and the bottom door portion 46 move vertically in response to vertical movement of the rod 76. The plunger 80 is connected to the bottom door portion 46 at a first end and is connected to the seal lift assist assembly 82 at a second end. The seal lift assist assembly 82 includes a plurality of constant force springs 82a, 82b that support the weight of the plunger 80 and thereby the bottom door portion 46. The constant force springs 82a, 82b of the seal lift assist assembly 82 permit a user to adjust a height of the bottom door portion 46 without the use of tools because the constant force springs bear the weight of the bottom door portion 46.

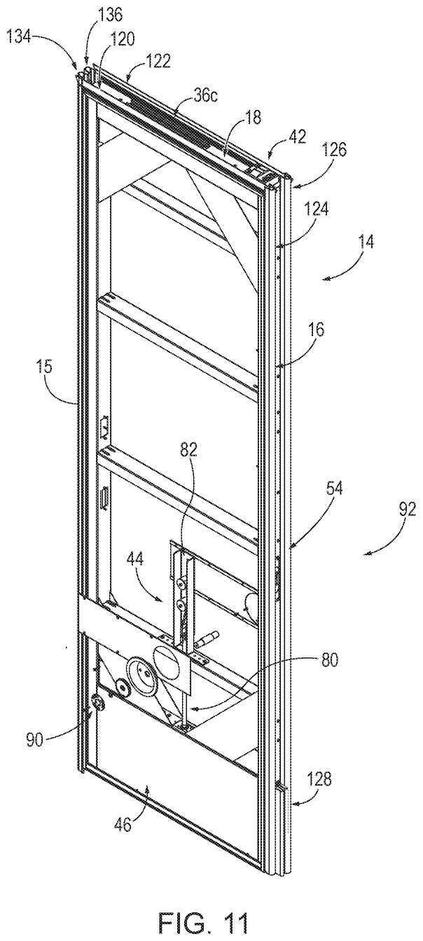

FIG. 11 shows the door height adjustment assembly 44 and the bottom door portion 46 installed in the door 14. From the perspective of FIG. 11, the following components are not visible: the handle 74, the rod 76, and the bottom block 78. The plunger 80 extends from the bottom door portion 46 into the seal lift assist assembly 82.

With reference again to FIG. 6, the user adjusts the frame height adjustment assembly 48 such that the bottom frame portion 50 engages the floor surface 4 with a desired force and forms a seal against the floor surface 4. After the frame height adjustment assembly 48 is adjusted, the user can adjust the position of the bottom door portion 46 with the door height adjustment assembly 44 to narrow a gap between the frame 12 and the floor surface 4. The bottom door portion 46 does not form a seal with the floor surface 4, such that the door 14 is permitted to pivot with respect to the frame 12. The bottom door portion 46 may be positioned to be almost abutting against or just skimming the floor surface such that the door 14 can open but the sound and light are essentially blocked by the door 14 while the door 14 is closed.

FIG. 11 also illustrates the user-engageable component 54, a first handle 90, and a second handle 92. The first and second handles 90, 92 can be engaged by users to open and close the door 14.

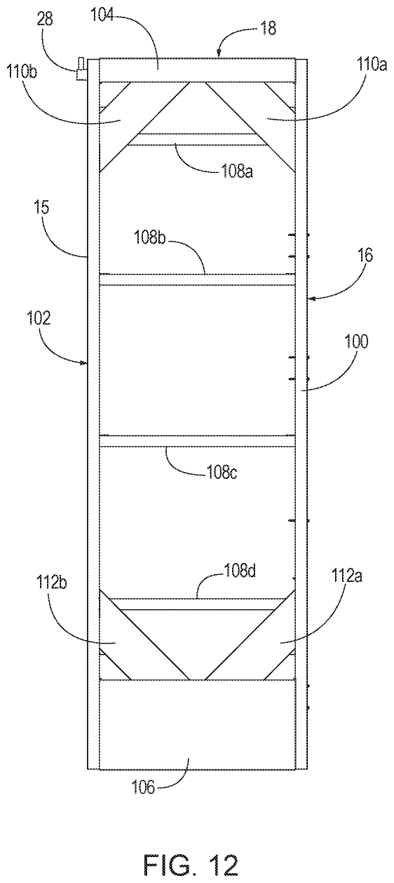

FIG. 12 illustrates a support system for the door 14 including a strike side vertical rail 100, a hinge side vertical rail 102, a top rail 104, a bottom rail 106, support rails 108a, 108b, 108c, 108d, upper brackets 110a, 110b and lower brackets 112a, 112b. The strike side vertical rail 100 forms the strike edge 16 and the hinge side vertical rail 102 forms the hinged side edge 15. The top rail 104 forms the door top edge 18 and extends between the strike side vertical rail 100 and the hinge side vertical rail 102. The bottom rail 106 extends between the strike side vertical rail 100 and the hinge side vertical rail 102.

The support rails 108a, 108b, 108c, 108d each extend between the strike side vertical rail 100 and the hinge side vertical rail 102 at locations vertically spaced between the top rail 104 and the bottom rail 106.

The upper bracket 110a is connected to the top rail 104 and to the strike side vertical rail 100. The upper bracket 110b is connected to the top rail 104 and to the hinge side vertical rail 102. The lower bracket 112a is connected to the bottom rail 106 and to the strike side vertical rail 100. The lower bracket 112b is connected to the bottom rail 106 and to the hinge side vertical rail 102.

The strike side vertical rail 100, the hinge side vertical rail 102, the top rail 104, the bottom rail 106, the support rails 108a, 108b, 108c, 108d, the upper brackets 110a, 110b and the lower brackets 112a, 112b cooperate to inhibit sagging of the door 14 even though the door 14 is relatively large and heavy. In some embodiments, the upper brackets 110a, 110b and the lower brackets 112a, 112b are spot welded to the respective vertical rail 100, 102 and the respective top or bottom rail 104, 106.

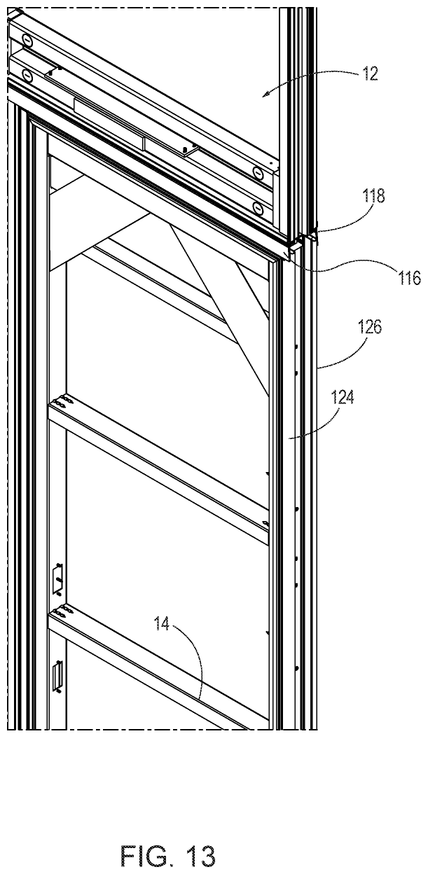

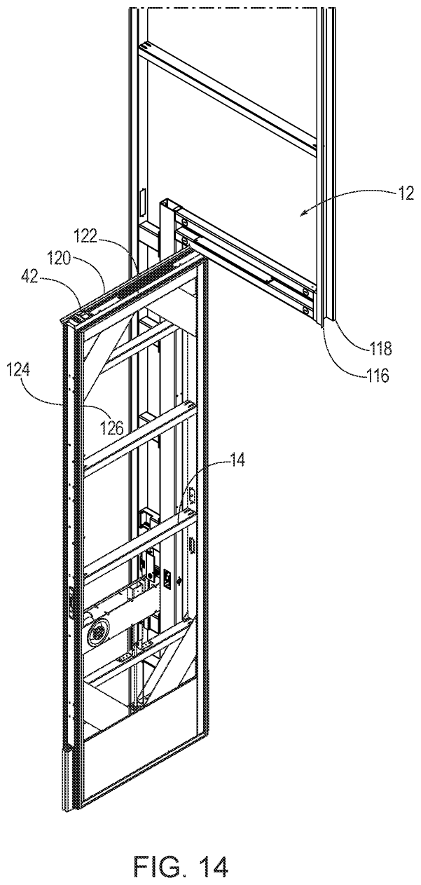

The door 14 is spaced a vertical distance from the frame 12 to permit the door 14 to pivot with respect to the frame 12. The vertical distance provides room for the closure mechanism 30 between the door top edge 18 and the frame head jamb 22. The vertical distance is covered by a plurality of horizontal sweeps as shown in FIGS. 13 and 14. A first horizontal sweep 116 is positioned on a first side of the frame head jamb 22 and a second horizontal sweep 118 is positioned on a second side of the frame head jamb 22. The first and second horizontal sweeps 116, 118 depend downwardly from the frame head jamb 22 toward the door top edge 18. A third horizontal sweep 120 is positioned on a first side of the door top edge 18 and a fourth horizontal sweep 122 is positioned on a second side of the door top edge 18. The third and fourth horizontal sweeps 120, 122 extend upwardly from the door top edge 18 toward the frame head jamb 22. The horizontal sweeps 116, 118, 120, 122 cooperate to close the gap between the door top edge 18 and the frame head jamb 22. The horizontal sweeps 116, 118, 120, 122 are flexible to permit the lower portion 36c to pivot with respect to the middle portion 36b.

The door 14 is spaced a horizontal distance from an adjacent panel to permit the door 14 to pivot with respect to the adjacent panel. The horizontal distance between the door 14 and the adjacent panel is covered or covered by a plurality of gaskets. A first gasket 124 is positioned on a first side of the strike edge 16 of the door 14 and a second gasket 126 is positioned on a second side of the strike edge 16 of the door 14. The first and second gaskets 124, 126 cooperate with any gaskets on the adjacent panel to cover the horizontal distance between the door 14 and the adjacent panel.

Referring now to FIGS. 4, 5, 8, 10, and 11, a third gasket 128 is positioned on a side surface the bottom door portion 46 to seal between the bottom door portion 46 and the adjacent panel. The third gasket 128 is sized to fit between the first and second gaskets 124, 126 (not visible in some views) to permit the bottom door portion 46 to move vertically with respect to remainder of the door 14 in response to the door height adjustment assembly 44.

The horizontal distance between the door 14 and the frame 12 is covered by a plurality of gaskets. With reference to FIGS. 6 and 9, a fourth gasket 130 and a fifth gasket 132 are positioned on a second side of the frame side jamb 20. A sixth gasket 134 is positioned on a first side of the hinged side edge 15 of the door 14 and a seventh gasket 136 is positioned on a second side of the hinged side edge 15 (see FIGS. 6 and 11). The fourth, fifth, sixth and seventh gaskets 130, 132, 134 and 136 can corporate to cover the horizontal distance between the door 14 and the frame 12.

With reference to FIGS. 6, 8, and 10, an eighth gasket 138 is positioned on the bottom frame portion 50 at the frame side jamb 20 and a ninth gasket 140 is positioned on the bottom door portion 46. The eighth and ninth gaskets 138, 140 cooperate to seal between the bottom door portion 46 and the bottom frame portion 50. The eighth gasket 138 is sized to fit between the fourth and fifth gaskets 130, 132 to permit the bottom frame portion 50 to move vertically with respect to remainder of the frame 12 in response to the frame height adjustment assembly 48. The ninth gasket 140 is sized to fit between the sixth and seventh gaskets 134, 136 to permit the bottom door portion 46 to move vertically with respect to remainder of the door 14 in response to the door height adjustment assembly 44.

In some embodiments, the door 14 is at least two inches thick and the door 14 is spaced from the frame 12 and the adjacent panel an adequate distance to permit the door 14 to open and close. In some embodiments, the door 14 is about four inches thick and the door 14 is spaced from the frame 12 and the adjacent panel an adequate distance to permit the door 14 to open and close. The horizontal sweeps and gaskets cooperate to close the gap between the door 14 and the frame 12 as well as between the door 14 and the adjacent panel to essentially block light and noise from passing through the gap between the door 14 and the frame 12 as well as the gap between the door 14 and the adjacent panel.

What is claimed is:

1. A moveable wall for use in a building having a fixed wall, a floor surface and a ceiling, the moveable wall comprising:
a panel including a door frame comprising a side jam and a head jam, the panel also including a top edge adjacent the ceiling, a bottom edge proximate the floor surface, a first side edge extending from the bottom edge to the top edge, and a second side edge extending from the head jam to the ceiling, the bottom edge extending between the first side edge and the side jam;
a door including a hinge edge that is hingedly mounted on a hinge axis to the side jam and a strike edge that is opposite the hinge edge, the door being in a closed position in which the door is parallel to the panel, a first open position when the door is pivoted about the hinge axis from the closed position in a first pivoting direction, and a second open position when the door is pivoted about the hinge axis from the closed position in a second pivoting direction opposite the first pivoting direction;
a moveable bottom panel portion coupled to and movable with respect to the bottom edge of the panel; and
a height adjustment assembly that selectively moves the moveable bottom panel portion with respect to the bottom edge of the panel into and out of engagement with the floor surface, the height adjustment assembly being actuated by a user without the use of tools.

2. The moveable wall of claim 1, wherein the height adjustment assembly includes a rack and a rack-engaging portion, actuation of the rack-engaging portion causes movement of the rack, and the movable bottom panel portion moves in response to movement of the rack.

3. The moveable wall of claim 2, wherein the rack-engaging portion comprises a square drive, the height adjustment assembly further comprising a crank selectively engageable with the square drive, and wherein the user rotates the crank to rotate the square drive.

4. The moveable wall of claim 1, wherein the height adjustment assembly moves the moveable bottom panel portion up to ten inches with respect to the bottom edge toward the floor surface.

5. The moveable wall of claim 1, wherein the panel is a first panel, and further comprising
a second panel including a top edge adjacent the ceiling, a bottom edge proximate the floor surface, a first side edge extending from the bottom edge to the top edge, and second side edge extending from the bottom edge to the top edge, wherein the first side edge is configured to be positioned adjacent the fixed wall and the second side edge is configured to be positioned adjacent the first side of the first panel while the first and second panels are deployed, and
a third panel including a top edge adjacent the ceiling, a bottom edge proximate the floor surface, a first side edge extending from the bottom edge to the top edge, and second side edge extending from the bottom edge to the top edge, wherein the first side edge is configured to be positioned adjacent the second side of the first panel while deployed, such that an edge of the door is positioned proximate the first side of the third panel when the door is in the closed position.

6. The moveable wall of claim 5, further comprising gaskets positioned on the strike edge of the door, on the hinge edge of the door, on side jam of the door frame, and on the first edge of the third panel, the gaskets configured to close a first gap between the hinge edge of the door and the side jam and configured to close a second gap between the strike edge of the door and the first edge of the third panel.

7. The moveable wall of claim 1, further comprising a door closure having a first portion connected to the top edge of the door, a second portion connected to the head jam, and a third portion connected to the first portion and the second portion, the door closure configured to inhibit rotation of the door from the closed position more than 90 degrees in either of the first and second pivoting directions, and further comprising at least one sweep mounted to at least one of the top edge of the door and the head jam to close a gap between the top edge of the door and the head jam.

8. The moveable wall of claim 1, further comprising a moveable bottom door portion coupled to and movable with respect to the bottom edge of the door to narrow a gap between the bottom edge of the door and the floor surface.

9. The moveable wall of claim 8, further comprising a handle engageable by a user to raise and lower the moveable bottom portion of the door and a lift assist assembly configured to bear at least a portion of a weight of the moveable bottom portion of the door, such that by engaging the handle a user can adjust a position of the moveable bottom portion with respect to the fixed main portion of the door without the use of tools.

10. The moveable wall of claim 9, wherein the lift assist assembly includes at least one constant force spring connected to the fixed main portion of the door and connected to the moveable bottom portion of the door such that substantially the entire weight of the moveable bottom portion of the door is carried by the fixed main portion of the door.

11. The moveable wall of claim 10, wherein the handle is positioned on the hinge side of the door, such that while the door is open, the handle is graspable by a user to pivot to an unlocked position to permit the user to adjust a height of the moveable bottom portion of the door and to pivot to a locked position to retain the moveable bottom portion of the door with respect to the fixed main portion of the door.

12. The moveable wall of claim 1, further comprising a plurality of support rails extending horizontally between the strike side and the hinge side of the door, and a plurality of brackets, the plurality of support rails spaced vertically apart between a top of the door and a bottom of the door, the brackets extending between adjacent ones of the hinge side, the strike side, the top of the door and the bottom of the door, the support rails and the brackets configured to resist deflection of the door during operation.

13. A moveable wall for use in a building having a fixed wall, a floor surface and a ceiling, the moveable wall comprising:
a panel including a door frame comprising a side jam and a head jam, the panel also including a top edge adjacent the ceiling, a bottom edge proximate the floor surface, a first side edge extending from the bottom edge to the top edge, and a second side edge extending from the head jam to the top edge, the bottom edge extending between the first side edge and the side jam;
a door including a hinge edge that is hingedly mounted on a hinge axis to the side jam and a strike edge that is opposite the hinge edge, the door also including a top edge proximate the head jamb, a bottom edge proximate the floor surface, the door being in a closed position in which the door is parallel to the panel, a first open position when the door is pivoted about the hinge axis from the closed position in a first pivoting direction, and a second open position when the door is pivoted about the hinge axis from the closed position in a second pivoting direction opposite the first pivoting direction;
a moveable bottom door portion coupled to and movable with respect to the bottom edge of the door; and
a height adjustment assembly that selectively moves the moveable bottom door portion with respect to the bottom edge of the door toward the floor surface to narrow a gap between the bottom edge of the door and the floor surface, the height adjustment assembly being actuated by a user without the use of tools.

14. The moveable wall of claim 13, wherein the height adjustment assembly includes a handle engageable by a user to raise and lower the moveable bottom portion of the door and wherein the handle is positioned on the hinge side of the door, such that while the door is open, the handle is graspable by a user to pivot to an unlocked position to permit the user to adjust a height of the moveable bottom portion of the door and to pivot to a locked position to retain the moveable bottom portion of the door with respect to the fixed main portion of the door.

15. The moveable wall of claim 13, further comprising a lift assist assembly configured to bear at least a portion of a weight of the moveable bottom portion of the door, such that a user can adjust a height of the moveable bottom portion of the door without the use of tools.

16. The moveable wall of claim 15, wherein the lift assist assembly includes at least one constant force spring connected to the fixed main portion of the door and connected to the moveable bottom portion of the door such that substantially the entire weight of the moveable bottom portion of the door is carried by the fixed main portion of the door.

17. A moveable wall for use in a building having a fixed wall, a floor surface and a ceiling, the moveable wall comprising:
a panel including a door frame comprising a side jam and a head jam, the panel also including a top edge adjacent the ceiling, a bottom edge proximate the floor surface, a first side edge extending from the bottom edge to the top edge, and a second side edge extending from the head jam to the top edge, the bottom edge extending between the first side edge and the side jam;
a moveable bottom panel portion coupled to and movable with respect to the bottom edge of the panel;
a panel height adjustment assembly that selectively moves the moveable bottom panel portion with respect to the bottom edge of the panel into and out of engagement with the floor surface, the panel height adjustment assembly being actuated by a user without the use of tools;
a door including a hinge edge that is hingedly mounted on a hinge axis to the side jam and a strike edge that is opposite the hinge edge, the door also including a top edge proximate the head jamb, a bottom edge proximate the floor surface, the door being in a closed position in which the door is parallel to the panel, a first open position when the door is pivoted about the hinge axis from the closed position in a first pivoting direction, and a second open position when the door is pivoted about the hinge axis from the closed position in a second pivoting direction opposite the first pivoting direction;
a moveable bottom door portion coupled to and movable with respect to the bottom edge of the door; and
a door height adjustment assembly that selectively moves the moveable bottom door portion with respect to the bottom edge of the door such that the moveable bottom door portion is adjacent the floor surface, the door height adjustment assembly being actuated by a user without the use of tools.

18. The moveable wall of claim 17, further comprising a door closure having a first portion connected to the top edge of the door, a second portion connected to the head jam, and a third portion connected to the first portion and the second portion, the door closure configured to inhibit rotation of the door from the closed position more than 90 degrees in either of the first and second pivoting directions, and further comprising at least one sweep mounted to at least one of the top edge of the door and the head jam to close a gap between the top edge of the door and the head jam.

19. The moveable wall of claim 18, wherein the panel is a first panel, and further comprising
a second panel having a first face, a second face opposite the first face, a first side and a second side opposite the first side, a top and a bottom, the top of the second panel positioned adjacent the ceiling and the bottom of the second panel positioned adjacent the floor surface, the first side of the second panel is configured to be positioned adjacent the fixed wall and the second side of the second panel configured to be positioned adjacent the first side of the first panel while the first and second panels are deployed,
a third panel having a first face, a second face opposite the first face, a first side and a second side opposite the first side, a top and a bottom, the top of the third panel positioned adjacent the ceiling and the bottom of the third panel positioned adjacent the floor surface, the first side of the third panel configured to be positioned adjacent the second side of the first panel while deployed, such that the door is positioned adjacent the first side of the third panel while the door is closed, and
a plurality of gaskets positioned on the strike side of the door, on the hinge side of the door, on the frame adjacent the door and on the first side of the third panel, the gaskets configured to cover a first gap between the hinge side of the door and the frame adjacent the door and configured to cover a second gap between the strike side of the door and the third panel.

20. The moveable wall of claim 17, further comprising a plurality of support rails extending horizontally between the strike side and the hinge side of the door, and a plurality of brackets, the plurality of support rails spaced vertically apart between a top of the door and a bottom of the door, the brackets extending between adjacent ones of the hinge side, the strike side, the top of the door and the bottom of the door, the support rails and the brackets configured to resist deflection of the door during operation.
